(19) United States
(12) Patent Application Publication
(10) Pub. No.: US 2007/0211082 A1
(43) Pub. Date: Sep. 13, 2007

(54) Method and System for Volatile Construction of an Image to be Displayed on a Display System from a Plurality of Objects

(76) Inventors: Philippe Hauttecoeur, Les Ulis (FR); Herve Rostan, Mittainville (FR)

Correspondence Address: YOUNG & THOMPSON, 745 SOUTH 23RD STREET, 2ND FLOOR, ARLINGTON, VA, 22202, US

(21) Appl. No.: 11/547,812

(22) PCT Filed: Apr. 8, 2005
(86) PCT No.: PCT/FR05/00857

§ 371 Date: Oct. 6, 2006

(30) Foreign Application Priority Data
Apr. 8, 2004 (FR) 0403721

(51) Int. Cl. G01V 5/00

(52) U.S. Cl. 345/634

(57) ABSTRACT

A method for building an image displayable on a screen (1) from a plurality of objects (2) stored in a memory (3). The method includes building for each video frame of the screen (1) a line-at-a-time image directly from the objects (2) and involves the following stages: for each screen line, to build on-the-fly the line by retrieving and storing all pixels related to the objects displayable on the line in a line memory (8) in a real time and to display (9) the pixels by sending them to the screen according a pixel sequence and at a pixel frequency in such a way that the image is formed on the screen (1) only.

This invention relates to a method of constructing an image to be displayed on a display system, such as a screen from a plurality of objects. An object is a graphic element which can be displayed on the screen. It can, for example, be of the video, bitmap, or vector type.

Whereas the “object” approach is a widely used notion at application level, current display mechanisms usually limit themselves to searching for the image already constructed somewhere in the memory, in a predefined zone which is generally the size of a video frame, hence its name “frame buffer”. An object-copying module is commonly used between an application module managing objects and a display module operating a frame buffer, allowing an object to be retrieved from any zone to be retrieved and written in the frame buffer.

Graphic and video systems according to the prior art use frame memories in which the images are made from graphical and video primitives and objects copied into these zones. When there are several memory planes, these are generally recombined at the moment of display using multiplexing, “chroma-keying” or “alpha-blending” mechanisms. This approach takes up lots of memory space, above all for systems wishing to offer a very good visual quality and which thus require multiple memory planes. Moreover, whenever a graphic object is replaced by another, deleted or moved, the frame buffer in which it is located is totally reconstructed, and thus there is a loss of fluidity.

For standard systems, the dynamism and visual quality that it is wished to bring to the Man-Machine Interface dictate every dimension of the processor core of the system (hardware and/or software) and the memory size. Thus:

the more powerful the processor, the more it will be able to perform a large number of operations during the preparation of the image planes and manage major content modifications from one frame to the next, and the more it will be able to handle a large number of memory planes;

the more memory planes there are, the larger will be the number of graphic levels, which increases the possibilities in terms of complex transparency in the final image.

This invention aims to deal with the above-named disadvantages by proposing a method of image construction in which the memory useful for this construction and the useful power of the system are reduced compared with the systems of the prior art.

The above-mentioned aim is achieved by a method of constructing an image suitable for being displayed on a display system from a plurality of objects. According to the invention, for each video frame of the display system the image is constructed line-by-line directly from the objects, carrying out the following steps:

for each line of the display system, this line is constructed instantly (“on the fly”), retrieving and storing, in real time, in at least one line buffer, all the pixels relative to the objects intended to be displayed on said line, and

these pixels are sent to the display system according to a pixel sequence, such that the image is formed only on said display system; and in that the line construction mechanism is line- and frame-synchronized with the display system.

Unlike the systems of the prior art, this invention allows the direct display of the objects on a display system such as a screen. The object is at the core of the image construction mechanism. The construction of the image is said to be volatile since its mechanism does not use a frame buffer and the image exists only on the display system. In other words, the image is constructed line-by-line in real time from the places where the objects are disseminated as far as the display system. Whereas in the systems of the prior art, the image is constructed firstly from the objects, this image is stored in a frame buffer, then the already-formed image is displayed.

By display system is meant a system comprising one or more line- and frame- synchronized screens, driven by a single controller generating signals that clock from the screens, this controller being located in the accelerator. For example, as seen from the accelerator, two screens side-by-side can be considered a single double-definition screen.

The display system can also comprise a display memory suitable for receiving the pixels forming the image. The image is then formed within this display memory rather than directly on a screen.

Moreover, when the graphic or video objects are stored in memories in compressed form, this invention offers a certain advantage compared with standard systems as it requires little memory (no frame buffer), thus a lower manufacturing cost.

In addition, since the image is constructed directly, the operation of preparing the frame in a frame buffer is avoided, hence a reduction in the bandwidth necessary at memory level. As it has fewer operations to carry out in order to display an image on the screen the whole system can be less powerful, and therefore consume less energy and is thus less demanding, which is essential for a embedded system for example. This invention therefore allows images of very high visual quality to be produced from low-power components.

Since the image which an observer sees exists only on screen and is not stored, the image must be reconstructed at each new video frame. As a consequence, the production of sequences of complex images with dynamic objects does not require any additional power compared with what is necessary to always display the same image. On the other hand, standard systems are rarely capable of dynamizing their Man-Machine Interface (MMI), or do so to the detriment of the real time aspect, since the large number of operations necessary for preparing the image in the frame buffer can exceed the time of the video frame on the screen. For a standard graphic coprocessor, the dynamic aspect of an image (of an MMI) determines the dimensions. With this invention, a dynamic image can be obtained without redimensioning, since the number of operations to be carried out in the time frame will be the same. By dynamic image is meant an image composed of 2D objects that can change over time, move, transform itself, change state etc.

According to an advantageous embodiment of the invention, two line buffers are used, each successively carrying out, shifted, a construction step then a display step such that when a first line buffer displays pixels on the current line, pixels intended to be displayed on the following line are constructed and stored in the second line buffer.

Generally, during the image-construction step the following steps are carried out for each line of the display system:

each object that must be present on this line is identified independently according to a set of variables specific to each object;

in each object thus identified a useful zone corresponding to the considered line is detected; and

the raw data from said useful zone is converted into pixels compatible with the display format.

Preferably, during the detection step, the memory where the objects are stored is accessed from electronic mechanisms and the raw data from the useful zones is stored temporarily in storage means.

Advantageously, once the raw data is converted into pixels, transformations and effects can be applied to these pixels. These transformations and effects, which are in fact digital operations, can for example be a partial display or “clipping”, redimensioning, transparency, thresholding, anamorphism, filters, etc. As the object is at the core of the mechanism, each object is therefore independently parameterable and the parameters of an object can be changed without affecting the other objects. The production of an MMI is thus greatly simplified.

According to the invention, to write a pixel in a line buffer, firstly the position of this pixel in the considered line can be determined then also the value of the pixel already present at the same position in this line. Moreover, while writing a pixel in a line buffer, as this pixel is intended to be displayed at a given position on a line of the display system, a blender can be applied between this first pixel and a second pixel currently stored in the line buffer at said same given position, if the blender is applied proportionally to the level of transparency of said first pixel.

According to an advantageous embodiment of the invention, the video frame comprising two separate time intervals, a so-called “vertical blanking interval” (VBI) and a so-called “vertical active interval” (VAI), respectively corresponding to the interval between the two active frames and to the period of display of an active frame, the construction and display steps are carried out instantly during each vertical active interval, and any preparation necessary to the progress of the construction is carried out during the vertical blanking interval. Said “necessary preparation” can be any action preparing for the future frame.

Alternatively, any preparation necessary to the progress of the construction, the construction steps and the on-the-fly display can be carried out during each vertical active interval. In this case, said “necessary preparation” is preferably any action preparing for or anticipating construction of the future line.

This preparation can comprise the determining or the updating (when the variables are already determined) of a set of variables specific to each object. These variables can be extracted from each hardware descriptor associated with each object, then stored within the accelerator. A hardware descriptor is all of the graphic and display parameters defining the corresponding object. The objects can be of different types. They can be video, vector, bitmap, or other objects. Thanks to the descriptor, heterogeneous objects can be managed in the same way.

Said preparation can also comprise a sorting of the objects in, for example, descending or ascending order of depth so as to hierarchize the order with which the objects will be overlaid on the screen. The sorting can be carried out scanning first all the objects to determine the most buried object, then resuming the scanning of the objects without taking into account the objects already sorted, until all the objects are sorted. However, the sorting can take place during construction.

The volatile construction mechanism according to the invention allows a depth level to be taken into account for each object for the final display, allowing the management of overlaps of objects and the windows to be simplified from an application point of view, delegating this complex work, also tiresome from a software point of view, to the “hardware”. From a theoretical point of view the invention does not impose a maximum number of managed levels. In addition, this invention allows a very large number of graphic layers to be managed without penalty or dimensioning, in terms of “hardware” resources, CPU power, and memory quantity. Complex transparencies can thus be easily achieved: several transparent objects, one above/below the other.

Advantageously, the construction of the image is managed by a hardware accelerator using electronic mechanisms, i.e. a hardware management, an electric management by status machines. This hardware accelerator is suitable for generating the video frame of the display system. However, it can also synchronize and lock on this video frame of the display system from synchronization information provided by the display system itself.

According to another feature of the invention, a system is proposed for constructing an image suitable to be displayed on a display system from a plurality of objects in particular stored in the random access memory. According to the invention, the system comprises a processing unit such as a microprocessor combined with a hardware accelerator:
to construct the image, line-by-line, directly from the objects, retrieving and storing in real time, in a line buffer, all the pixels relating to the objects intended for display on each active line of each video frame of the display system,
to display these pixels sending them to the display system according to a pixel sequence at the pixel frequency, such that the image is formed only on said display system, and
to synchronize the construction mechanism of the line, by line and by frame, with the display system.

Advantageously, the hardware accelerator comprises the following elements:
an object manager to activate and characterize operations linked to objects,
a memory storing the parameters and variables of each object,
a DMA (“Direct Memory Access”)-type hardware module controlled by the accelerator (and not by the processing unit) suitable for retrieving object data from a memory,
a buffer for temporarily storing the data from the DMA hardware module,
a module decompressing and converting raw data from the buffer as pixels,
a multiplexer for selecting the pixel to be displayed between that from the decompression and conversion module and that from an external source, on the condition that the external source, the accelerator and the screen are synchronized,
a blender for blending the pixel from the multiplexer and a pixel currently displayed according to the transparency of the pixel from the multiplexer, and
two line buffers successively carrying out in turn the display of previously stored pixels on the current line of the display system, and the storage of pixels from the blender which will be displayed on the following line.

In the manner of an OSD (On Screen Display), this system comprises means of inserting/insetting graphic information in a main video stream. Unlike with such a display, the inserted information is the heterogeneous and parametric objects.

Other advantages and characteristics of the invention will appear on examining the detailed description of an embodiment, which is in no way limitive, and the attached drawings, in which:

FIG. 1 is a simplified diagrammatic view of a construction and display procedure of an image according to the prior art;

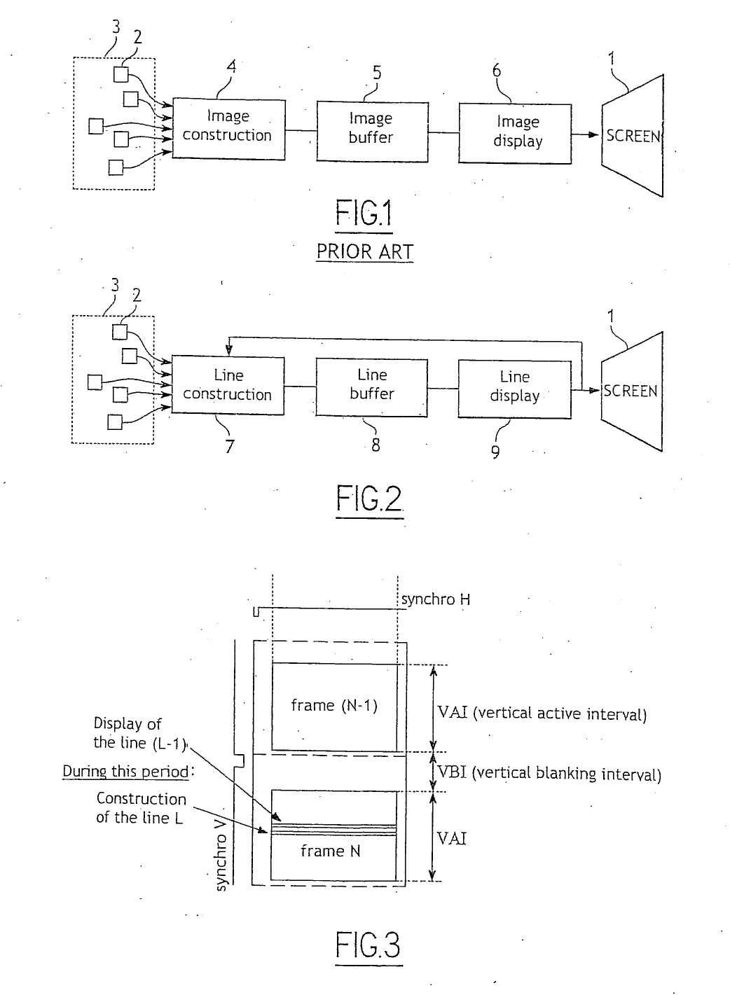

FIG. 2 is a simplified diagrammatic view of a construction and display procedure of a line-by-line real-time image according to this invention;

FIG. 3 is a diagram illustrating two time intervals of a video frame according to the invention;

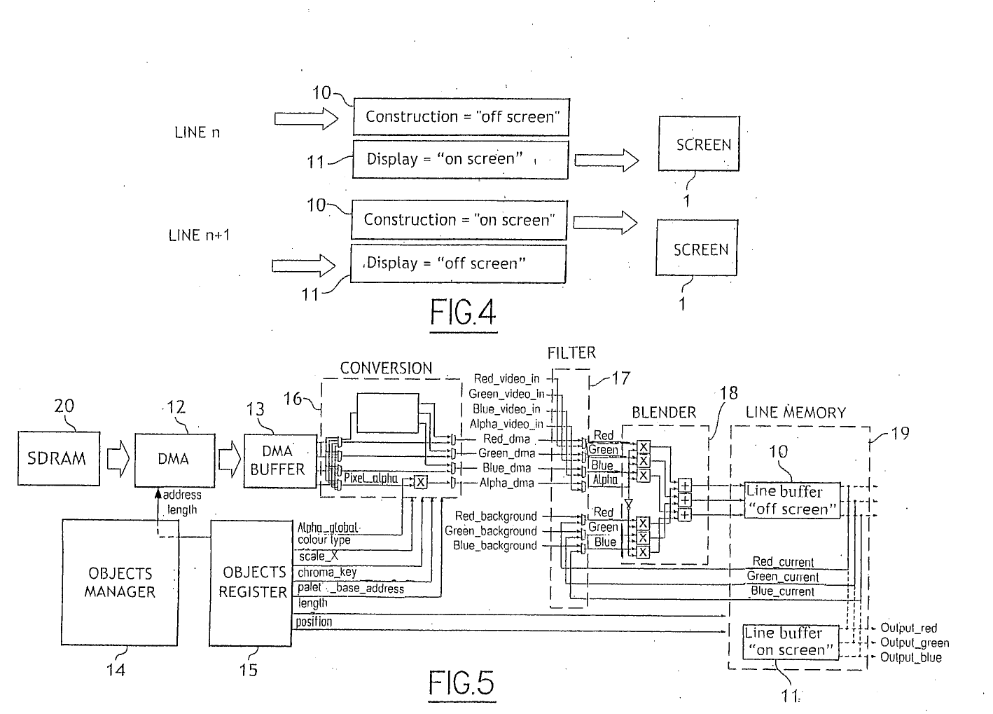

FIG. 4 is a diagram illustrating the manner in which two line buffers are used for the line-by-line construction and display of a image according to the invention;

FIG. 5 is a simplified diagrammatic view of a hardware accelerator implementing the method according to this invention.

In FIG. 1 it is desired to produce and display on a screen 1 an image from a plurality of objects 2 contained in a random access memory 3. In order to do this, according to the prior art, an object-copying module 4 constructs said image which is then stored in a frame buffer 5. The latter is generally the size of a video frame. A display module 6 then limits itself to fetching the already-constructed image from the frame buffer 5 and displaying it on screen 1 for the duration of a video frame.

This invention puts into practice a completely different method. In FIG. 2, it is again desired to display an image on screen 1 from a plurality of objects 2 stored in random access memory 3. In order to do this, a hardware processor is used, otherwise called a graphic hardware accelerator, to construct said image from objects 2 instantly and in real time. This accelerator, represented in particular in FIG. 5, performs different operations in the course of the video frame and repeats them at each new frame. Thus, during a frame, for each active line of the frame, the system according to the invention constructs the pixels in real time before being displayed on this line from objects 2. In other words, the hardware accelerator comprises a module 7 for constructing the pixels of a current line of the image to be displayed, at least one line buffer 8 for temporarily storing the thus-constructed pixels, and a line display module 9 on the screen 1.

Generally, in the video frame which it generates or on which it synchronizes and locks, the hardware accelerator then identifies, in accordance with FIG. 3, two separate time intervals which are:
the so-called “vertical blanking interval”, VBI
the so-called “vertical active interval”, VAI

The volatile construction mechanism according to the invention is based on these time intervals in order to display an image composed of objects on the screen and which are stable during the time of a frame. Macroscopically, a distinction is drawn between the VBI and VAI. The VBI of the frame period is used to carry out all the preparation necessary to the satisfactory progress of the volatile construction which will take place in the VAI by a line procedure. For each active line of the screen, the volatile construction consists of filling a line buffer with the line segments of the objects which are active in the considered line. The content of the line buffer is then sent to the screen at the rate of the pixel frequency. As will be seen below with FIG. 4, according to this invention, when a line (L-1) is displayed, the following line (L) is under construction during this time.

In FIG. 3, synchro H corresponds to the line synchronization (horizontal), and synchro V corresponds to the frame synchronization (vertical).

The procedure carried out in the vertical blanking interval VBI in order to prepare the volatile construction of the vertical active interval VAI will now be described. The first step can consist of decoding a hardware descriptor in order to produce variables which will be used during the construction of the lines during the VAI interval.

A hardware descriptor is associated with each object. By “hardware descriptor” is meant a coherent set of data, generally created and initialized by an application procedure. This descriptor contains all the information enabling the hardware accelerator to display the object which is associated with it. This information, stored in particular in registers or memories, comprises graphic parameters describing the nature of the object and display parameters. The latter can be separated into essential parameters (position, display attributes such as transparency level, etc.) and conversion parameters (partial display or “clipping”, resizing, rotation, anamorphism, filters, etc.). Each object can be of a different type in that it belongs to a given class (vector, video, bitmap, etc.) or includes a given colour scheme (palette mode, black and white, 16-, 24-, 32-bit colours, with or without transparency, etc.).

The descriptor can be local to the hardware accelerator or in an external memory. In this latter case the descriptor should be retrieved first before starting on the decoding.

The decoding of the descriptor consists of extracting from it all the variables which will be used during the volatile construction. The decoding of the descriptor will be of a greater or lesser length and complexity, depending on the ability of the hardware accelerator to perform advanced and complex functions (filters, “resizing”, anamorphism, “clipping”, movements, etc.). The decoding of certain information of the descriptor may even be pointless if the parameters provided already correspond to the variables useful for the volatile construction. Nevertheless, the idea consists of delegating to hardware level the preprocessing of the raw data in order that it can guarantee real time and be synchronized in the frame with the volatile construction. This also permits the storage in the descriptor of the advanced parameters which will be directly (or almost directly) transmitted by an application called API (“Application Program Interface”) which is object-oriented. In fact, the hardware accelerator is combined with a microprocessor which is programmed so as to offer a set of predefined functions accessible via this API.

To illustrate the role of decoding, for an object composed for example of a bitmap image stored somewhere in memory. Its descriptor thus contains:
the address where the stored image data starts;
the size of the image;
the position of the object on the screen;
the colour scheme of the bitmap image as it is stored in memory;
the overall transparency level of the object; . . .

Let us imagine that the coordinates of the object are slightly negative compared with the original on the screen only the visible part of the object will have to be processed to be displayed, the remainder being clipped. This means that the object's real position will have to be determined, that the address of the stored object will have to be updated in order to point directly at the first visible pixel. The size of the line segment useful for the volatile construction of a line must also be determined according to the clipping, but also according to the colour scheme of the stored pixels. Thus, for each object, the decoding of the descriptor leads to a series of operating variables which will be utilized by the hardware accelerator during the volatile construction. While the descriptors can be stored in an external memory, the useful variables will advantageously be stored locally to the hardware accelerator for reasons of accessibility. Some of these variables will undergo modifications as the line procedure progresses. For example, when the decoding of the descriptor is finished, the address pointer points to the first active line segment of the stored object. But the address pointer will have to point according to the progress of the line procedure on the new active line segments.

A second step can be the sorting of objects in decreasing order of depth. This procedure allows the order with which the objects will be overlaid on the screen to be hierarchized. It is most useful when the overall transparency of the objects is managed by the hardware accelerator, as it then permits the faithful restoration of the complex transparency between the objects.

This means that an object A placed behind an object B will be seen proportionally to the transparency of object B which is located in front of it. Sorting can take place, for example, scanning firstly all the objects in order to determine the deepest-buried object, then resuming the scanning of the objects without taking into account the already sorted objects, until all the objects are sorted. At the end of this scanning, each object can for example contain in one of its registers the index of the following object in decreasing order of depth, in order that the image construction line procedure can move easily from one object to another, and in the order required by the complex transparency.

Complex transparency is achieved only through the inventive principle of volatile construction according to the invention which is described below.

The procedure carried out in the vertical active interval VAI will now be described. The volatile image construction mechanism is a line procedure, which means that it repeats for each active line of the screen, i.e. for each line of the VAI (see FIG. 3).

Line procedure:

The construction mechanism for a line is synchronized with the display mechanism which consists simply of sending a pixel sequence at the pixel frequency to the screen. In order to do this, it is perfectly possible to use only a single line buffer for these two mechanisms, in the knowledge that the construction mechanism must then be timed-out in order not to update pixels which have not yet been sent to the screen. Two or more line buffers can also be used. In this case, some, called “off screen”, are used to construct the following lines, while one called “on screen” is sent to the screen to fill the current line. At the line frequency, for example at the time of the line synchro pulse, the procedures are reversed. The “off screen” memory becomes the “on screen” memory and vice versa. FIG. 4 illustrates this mechanism on two successive lines Line n and Line n+1 where the reversal of roles between the two memories 10 and 11 is observed.

Construction of the line:

For a given line of the screen, all the segments of the objects which must be located in this line are retrieved.

In order to know if an object is located in the line, a procedure is carried out which makes it possible, successively for each object, to verify whether the object is present or not in the line of screen being considered. The fact that an object is or is not present in a line of the screen depends on several parameters which are specific to each object. In the case of a rectangular bitmap object stored as such and displayed as such, there may be mentioned:
the height of the object (in number of pixels);
the “y” coordinate of the object (in number of pixels compared with a conventional source).

If the object has a clipping area allocated to it, the parameters of this area will also be taken into account.

If the object has to undergo a vertical resizing, the final size of the object will be taken into account, i.e. on the screen, in order to determine if a piece of this object is located in the screen line considered.

When it is known that an object is present in the active line, it is still necessary to determine what is the useful area of this object in the considered line, know where and how to retrieve this area, and know where to place it in the line buffer. For example, in the case of a rectangular bitmap object stored and displayed anamorphized on the screen, the retrieval of the useful segment makes it necessary to determine among other things:
the memory address where the first pixel of the object segment is located;
the number of pixels contained in the segment of the object;
the law of horizontal and vertical variation between two pixels.

The determination of these variables is not sufficient to retrieve the useful segment of the object. The following object parameters must also be considered:
the width of the object stored (in octets);
the colour scheme of the pixels;
the compression law, if the object is stored in a compressed way.

In terms of the actions to be carried out: a procedure is executed making it possible, successively for each object:

a) to calculate the variables necessary for the retrieval of the useful segment;

b) to retrieve the necessary object parameters;

c) to update the variables in the registers ready for the next lines, for example the memory address pointer.

A procedure is also carried out making access to the memory possible where the objects are stored, from hardware commands. For example, “DMA” “Direct Memory Access” hardware, managed by the hardware accelerator, may be mentioned compared with a DMA traditionally managed by a microprocessor.

A procedure is also carried out that allows the DMA to be controlled and monitored.

The volatile construction “hardware” mechanism according to the invention can advantageously be implemented in an FPGA which permits the integration of all the modules and procedures necessary for implementing the method according to the invention. FIG. 5 shows how a hardware accelerator 21 can be architectured on such an FPGA.

A memory 20 (SDRAM, DDRAM etc.) is advantageously used to store the graphic objects, its bandwidth being large enough to allow the volatile construction mechanism to retrieve sufficient information (useful data of the active objects) during the line procedure. This memory 20 is a random access memory external to the accelerator 21.

In FIG. 5 there can be seen:

a) An object manager 14 carrying out the activation and the characterization of the procedures specific to the object t (intra-object) as well as management between the objects (inter-objects).

b) A register 15 storing operating parameters and variables for each object.

c) A “DMA hardware” module 12 controlled by the object manager 14 and capable of searching for the data (for example bitmap images) in the external memory 20.

d) A buffer 13 for temporarily storing the raw data originating from DMA 12, when the DMA procedures and a decompression/conversion pipeline 16 are not synchronized.

e) Two line buffers 19, (one “off screen” and the other “on screen” in accordance with FIG. 4).

f) The pipeline 16 decompressing/converting raw data into pixels. More precisely, once the object segment is retrieved by the DMA, it is a matter of converting the raw data from the DMA into pixels in the output format adapted in order to be able to be stored in the line buffer. In the case of a bitmap image-type object, this requires knowledge of:
the colour scheme of the pixels;
the law of horizontal variation between two pixels;
the compression law if the image is stored in a compressed way.

This pipeline also comprises means of converting the pixels. Once the raw data is converted into pixels, it is possible to apply digital operations, such as for example filters or effects on these pixels. For example there may be cited:
“chroma-keying”: the pixel becomes transparent if its value is equal to a reference value which is called the “chroma-key” value;
thresholding by luminance: the pixel becomes transparent if the value of its luminance level is less than a reference value which is called threshold value;
thresholding by chrominance;
transparency level: the transparency level of the pixel called “alpha” is modified by applying the formula alpha_pixel =alpha_global_object×alpha_pixel_source;
colour filters: modification of the chrominance of the pixel;

low-pass, high-pass filters: influencing of the pixels next to the current pixel by a suitable pipeline;

etc.

g) A pixel blender (“blending”) 18 tracking the transparency of the pixel considered. The writing of pixels in the line buffer represents the final step in the line procedure of the volatile construction. The writing of a pixel in the memory requires knowledge of:
the position of the pixel in the line: “x” coordinate with respect to the origin equal to the first pixel on the screen;
the value of the pixel already present in the line at the same position, in particular when the object is semi-transparent.

h) A multiplexer 17 selects either the pixel from the main video stream (video_in), or the pixel from the stream from DMA 12. This mechanism requires the clocking of the accelerator to be synchronized and locked on the video source. The operating frequency of the pipeline is equal to several times the pixel frequency of the screen, and the multiplexer selects the video pixel at the rate of once per pixel period (at the pixel frequency). The rest of the time, the multiplexer manages the stream coming from the DMA 12. When there is no main video stream, this is replaced by a background colour. This example of architecture also allows the video to be merged with the background colour proportional to a video transparency level (alpha_video_in) without implementing a second blending module.

Thus, the method of constructing an image according to the invention makes it possible to manage the depth level between graphic and video objects with no limit to the maximum number of layers. This number of layers is not dimensioning in terms of accelerator hardware resources. This method also makes possible a management of the transparency between the graphic and video objects according to the positioning of objects on the z axes irrespective of the number of graphic layers which is not dimensioning in order to achieve the overall complex transparency.

The invention is, naturally, not limited to the examples which have just been described and numerous adjustments can be made to these examples without exceeding the scope of the invention.

1. Method of constructing an image suitable for being displayed on a display system from a plurality of objects; for each video frame of the display system, the image is constructed line-by-line directly from the objects, carrying out the following steps:
for each line of the display system, this line is constructed instantly, retrieving and storing, in real time, in at least one line buffer, all the pixels relating to the objects intended to be displayed on said line,
these pixels are sent to the display system according to a pixel sequence, such that the image is formed only on said display system; the line construction mechanism being line- and frame-synchronized with the display system; characterized in that when writing a pixel in a line buffer, as this pixel is intended to be displayed on a given position on a line of the display system, firstly the position of this pixel in the considered line is determined, and a blender is applied between this first pixel and a second pixel currently stored in the line buffer at said same given position, the blender being applied proportionally to the level of transparency of said first pixel so as to achieve complex transparency.

2. Method according to claim 1, characterized in that two line buffers are used, each successively carrying out, shifted, a construction step then a display step such that, when a first line buffer displays pixels on the current line, pixels intended to be displayed on the following line are constructed and stored in the second line buffer.

3. Method according to claim 1, characterized in that during the image-construction step the following steps are carried out for each line of the display system:
each object that must be present on this line is identified independently according to a set of variables specific to each object;
in each object thus identified a useful zone corresponding to the considered line is detected; and
the raw data from said useful zone is converted into pixels compatible with the display format.

4. Method according to claim 3, characterized in that during the detection step the memory where the objects are stored is accessed from electronic mechanisms and the raw data from the useful intervals is stored temporarily in storage means.

5. Method according to claim 3, characterized in that once the raw data is converted into pixels, transformations and effects are applied to these pixels.

6. Method according to claim 1, characterized in that while writing a pixel in a line buffer, the value of the pixel already present at the same position in this line is also determined.

7. Method according to claim 1, characterized in that the video frame comprises two separate time intervals, a so-called “vertical blanking interval” (VBI) and a so-called “vertical active interval” (VAI), respectively corresponding to the interval between the two active frames and to the period of display of an active frame, the construction and display steps are carried out instantly during each vertical active interval and any preparation necessary to the progress of the construction is carried out during the vertical blanking interval.

8. Method according to claim 1, characterized in that the video frame comprises two separate time intervals, a so-called “vertical blanking interval” (VBI) and a so-called “vertical active interval” (VAI), respectively corresponding to the interval between the two active frames and to the period of display of an active frame, any preparation necessary to the progress of the construction, the construction and display steps are carried out instantly during each vertical active interval.

9. Method according to claim 7, characterized that said preparation comprises the determination of a set of variables specific to each object.

10. Method according to claim 9, characterized in that the variables are extracted from each hardware descriptor associated with each object, then stored within the accelerator, a hardware descriptor being all of the graphic and display parameters defining the corresponding object.

11. Method according to claim 8, characterized in that said preparation also comprises a sorting of the objects in order of depth so as to hierarchize the order with which the objects will be overlaid on the display system.

12. Method according to claim 1, characterized in that the construction of the image is managed by a hardware accelerator using electronic mechanisms.

13. Method according to claim 12, characterized in that hardware accelerator is suitable for generating the video frame of the display system.

14. Method according to claim 12, characterized in that the hardware accelerator is suitable for synchronizing and locking on the video frame of the display system from synchronization information.

15. Method according to claim 1, characterized in that the display system comprises several synchronized screens.

16. Method according to claim 1, characterized in that the display system comprises a display memory suitable for receiving the pixels forming the image.

17. System for constructing an image suitable to be displayed on a display system from a plurality of objects, this system comprising a processing unit combined with a hardware accelerator:
to construct the image line-by-line directly from the objects, retrieving and storing, in real time, in a line buffer, all the pixels relating to the objects intended to be displayed on each active line of each video frame of the display system,
to display these pixels, sending them to the display system according to a pixel sequence, so that the image is formed only on said display system; and
to line- and frame-synchronize the line construction mechanism with the display system;
characterized in that, when writing a pixel in a line buffer, as this pixel is intended to be displayed at a given position on a line of the display system, said system for constructing an image comprises means for firstly determining the position of this pixel in the considered line, and for applying a blender between this first pixel and a second pixel currently stored in the line buffer at said same given position, the blender being applied proportionally to the level of transparency of said first pixel so as to achieve complex transparency.

18. System according to claim 17, characterized in that the hardware accelerator comprises the following elements:
an object manager for activating and characterizing operations linked to the objects,
a memory for storing the parameters and variables of each object,
a DMA (Direct Memory Access)-type hardware module controlled by the accelerator and suitable for retrieving data about the objects from a memory,
a buffer for temporarily storing the data from the DMA hardware module,
a module decompressing and converting raw data from the buffer as pixels,
a multiplexer for selecting the pixel to be displayed between that from the decompression and conversion module and that from an external source,
a blender for blending the pixel from the multiplexer and a currently displayed pixel according to the transparency of the pixel from the multiplexer, and
two line buffets successively carrying out in turn the display of previously stored pixels on the current line of the display system, and the storage of pixels from the blender which will be displayed on the following line.

19. System according to claim 17, characterized in that it comprises means for synchronizing on a video source and inserting graphic information into a video flow of said video source, not stored in the memory.

20. System according to claim 18, characterized in that it comprises means for synchronizing on a video source and inserting graphic information into a video flow of said video source, not stored in the memory.
